(19) United States
(12) Patent Application Publication
(10) Pub. No.: US 2007/0279538 A1
(43) Pub. Date: Dec. 6, 2007

(54) Display For Gaming Device

(76) Inventor: Alfred Thomas, Las Vegas, NV (US)

Correspondence Address: SCHWEGMAN, LUNDBERG & WOESSNER, P.A., P.O. BOX 2938, MINNEAPOLIS, MN, 55402, US

(21) Appl. No.: 10/591,379

(22) PCT Filed: Mar. 4, 2005
(86) PCT No.: PCT/US05/06686

§ 371 Date: Jul. 2, 2007

Related U.S. Application Data
(60) Provisional application No. 60/549,979, filed on Mar. 4, 2004.

(51) Int. Cl. G02F 1/13

(52) U.S. Cl. 349/1

(57) ABSTRACT

A mask is added to an LCD gaming device display to modify the appearance of content being displayed. In one embodiment, the mask comprises a dot stencil that results in a perceived increase in resolution and smoothing of curved shapes. In one embodiment, the stencils are added with layers of the LCD display to change the look of groups of tiny square pixels into the shape of large round dots. In a further embodiment, the mask comprises one or more groups of seven-segment stencils to create an illusion of a seven-segment LED display. Such displays may be used in bonus game meters.

### FIELD OF THE INVENTION

The present invention relates to gaming devices, and in particular to a display for a gaming device.

### BACKGROUND OF THE INVENTION

Gaming devices such as slot machines have evolved from using mechanical spinning reels to a video simulation of spinning reels. However, one of the primary draws to mechanical slots over video has been that players felt that the mechanical variety was more trustworthy. Players felt a mechanical slot would be more random instead of being “programmed” to lose. Players did not want to play a machine that was smarter than them.

One challenge was to create a new technology that appeared to be a low tech solution. Games were designed to extend the appeal of the game with interactive displays, while not being intimidating to long-time, traditional slot players. Once a video monitor was added to a slot machine, even if it was secondary to the actual mechanical reels, it was perceived as a video slot. In the pinball gaming world, low-resolution, gas-plasma displays were being used effectively. It used circular dots instead of pixels, which gave a distinctive look to artwork on the displays that was reminiscent of huge video signs in front of casinos, or LED signage displays above banks of slot machines. Such a dot based display was also fit into a slot machine cabinet to form a new type of mechanical slot.

As gaming devices (e.g., slot machines) continue to evolve, they continue to provide new and entertaining ways for presenting gaming content. Typically, gaming machines present at least two types of media, including primary media and secondary media. Primary media directly indicates various states of a game. For example, primary media includes content for representing the spinning reels of a slot machine. Primary media also includes content for representing the slot machine game results. In contrast, secondary media includes content for representing bonus schemes and other various informational and entertainment content. For example, secondary media can include information about slot machine bonuses, related progressive slot machine games, slot machine tournament information, etc. Additionally, secondary media can include content for entertaining slot machine players during various stages of a game.

Secondary media was introduced in the form of a flat-screed, LCD monitor. Players met it with little enthusiasm. One example screen shot of an image produced by the LCD monitor is shown in Prior Art FIG. 3. In an attempt to obtain a low-tech appearance, the result was large squares with sharp edges. While somewhat low tech in appearance, it was not visually appealing.

### SUMMARY OF THE INVENTION

A mask is added to a display device to modify the appearance of content being displayed. In one embodiment, the mask comprises a dot stencil that results in a perceived increase in resolution and smoothing of curved shapes.

In one embodiment, the mask is added with layers of an LCD display to change the look of groups of tiny square pixels into the shape of large round dots. The Mask may also be placed on the surface of the display and may contain stencils over only a portion of the display, and may contain text or graphics that cover portions of the display. In a further embodiment, the mask comprises one or more groups of seven-segment stencils to create an illusion of a seven-segment LED display. Such displays may be used in bonus game meters.

In a further embodiment, the mask contains graphics, which may be silk screened with a desired color. Such graphics are illuminated by pixels of the LCD display to create a pseudo-electroluminescent effect.

### BRIEF DESCRIPTION OF THE DRAWINGS

FIG. 1 is a perspective view of a gaming device, according to an example embodiment of the invention.

FIG. 2 is a block diagram illustrating components of a gaming device, according to an exemplary embodiment of the invention.

FIG. 3 is a prior art illustration of a LCD display having square pixels.

FIG. 4 is a representation of a display device according to an example embodiment of the invention.

FIG. 5 is an expanded view of the construction of a display device according to an example embodiment of the invention.

FIG. 6 is a prior art illustration of a LCD display having square pixels.

FIG. 7 is a representation of a display device according to an example embodiment of the invention.

FIGS. 8A and 8B are representations of a character on a display device and a mask used to modify the appearance of the character according to an example embodiment of the invention.

FIG. 9 is an expanded view of an alternative construction of a display device according to an example embodiment of the invention.

FIG. 10 is a representation of a display device having a mask overlaying the display device according to an example embodiment of the invention.

FIG. 11 is a representation of the display device of FIG. 10 wherein a portion of the mask is peeled back from the display device.

FIG. 12 is representation of a display device and a mask illustrating pseudo-electroluminescent graphics according to an example embodiment.

FIG. 13 is a representation of the display device and mask of FIG. 12 illuminated in an alternative manner.

FIG. 14 is a representation of the display device and mask of FIG. 12 illuminated in a further alternative manner.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

### Hardware and Operating Environment

This section provides an overview of the exemplary hardware and the operating environment in which embodiments of the invention can be practiced.

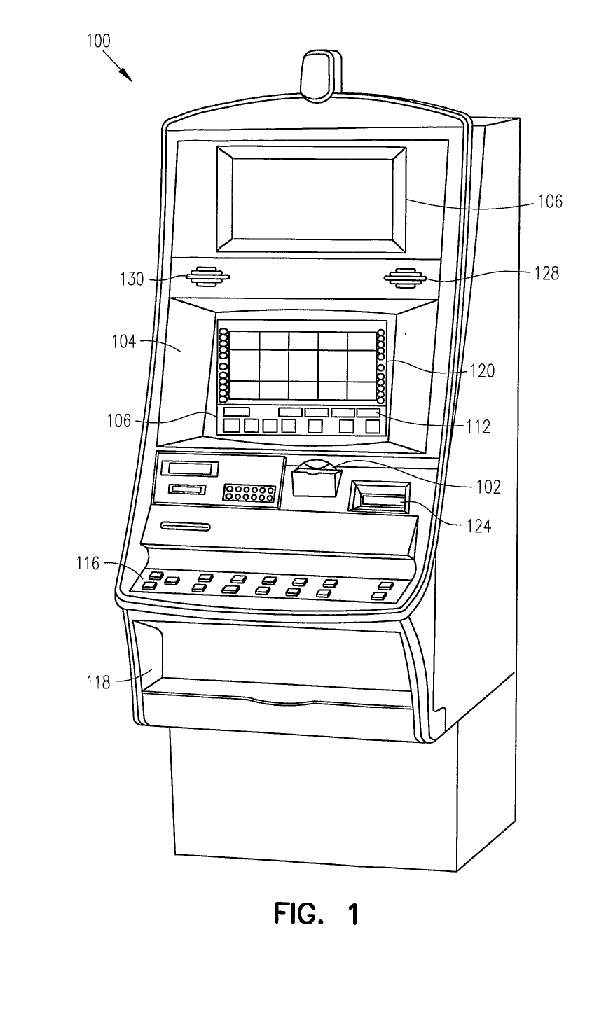

FIG. 1 is a perspective view of a gaming device 100, according to exemplary embodiments of the invention. As shown in FIG. 1, the gaming device 100 a slot machine in one embodiment having the controls, displays, and features of a conventional slot machine. The gaming device 100 can be operated while players are standing or seated. Additionally, the gaming device 100 is mounted on a console. However, it should be appreciated that the gaming device 100 can be constructed as a pub-style tabletop game (not shown), which a player can operate while sitting. Furthermore, the gaming device 100 can be constructed with varying cabinet and display designs. The gaming device 100 can incorporate any primary game such as slot, poker, or keno, and additional bonus round games. The symbols and indicia used on and in the gaming device 100 can take mechanical, electrical or video form.

As illustrated in FIG. 1, the gaming device 100 includes a coin slot 102 and bill acceptor 124. Players can place coins in the coin slot 102 and paper money or ticket vouchers in the bill acceptor 124. Other devices can be used for accepting payment. For example, credit/debit card readers/validators can be used for accepting payment. Additionally, the gaming device 100 can perform electronic funds transfers and financial transfers to procure monies from house financial accounts. When a player inserts money in the gaming device 100, a number of credits corresponding to the amount deposited is shown in a credit display 126. After depositing the appropriate amount of money, a player can begin playing the game by pulling the arm 108 or the pushing play button 110. The play button 110 can be any play activator used by the player to start a game or sequence of events in the gaming device 100.

As shown in FIG. 1, the gaming device 100 also includes a bet display 112 and a “bet one” button 114. The player places a bet by pushing the bet one button 114. The player can increase the bet by one credit each time the player pushes the bet one button 114. When the player pushes the bet one button 114, the number of credits shown in the credit display 106 decreases by one, and the number of credits shown in the bet display 112 increases by one.

A player may “cash out” by pressing a cash out button 116. When a player cashes out, the gaming device 100 dispenses a number of coins, corresponding to the number of remaining credits, into the coin tray 118. The gaming device 100 may employ other payout mechanisms such as credit slips, which are redeemable by a cashier, or electronically recordable cards, which track player credits.

The gaming device 100 also includes one or more display devices. The embodiment shown in FIG. 1 includes a primary display unit 104 and a secondary display unit 106. In one embodiment, the primary display unit 104 displays a plurality of reels 120. In one embodiment, the gaming device displays three reels, while an alternative embodiment displays five reels. In one embodiment, the reels are in video form. According to embodiments of the invention, the display units can display any visual representation or exhibition, including moving physical objects (e.g., mechanical reels and wheels), dynamic lighting, and video images. In one embodiment, each reel 120 includes a plurality of symbols such as bells, hearts, fruits, numbers, letters, bars or other images, which correspond to a theme associated with the gaming device 100. Furthermore, as shown in FIG. 1, the gaming device 100 includes a primary sound unit 128 and a secondary sound unit 130. In one embodiment, the primary and secondary sound units include speakers or other suitable sound projection devices.

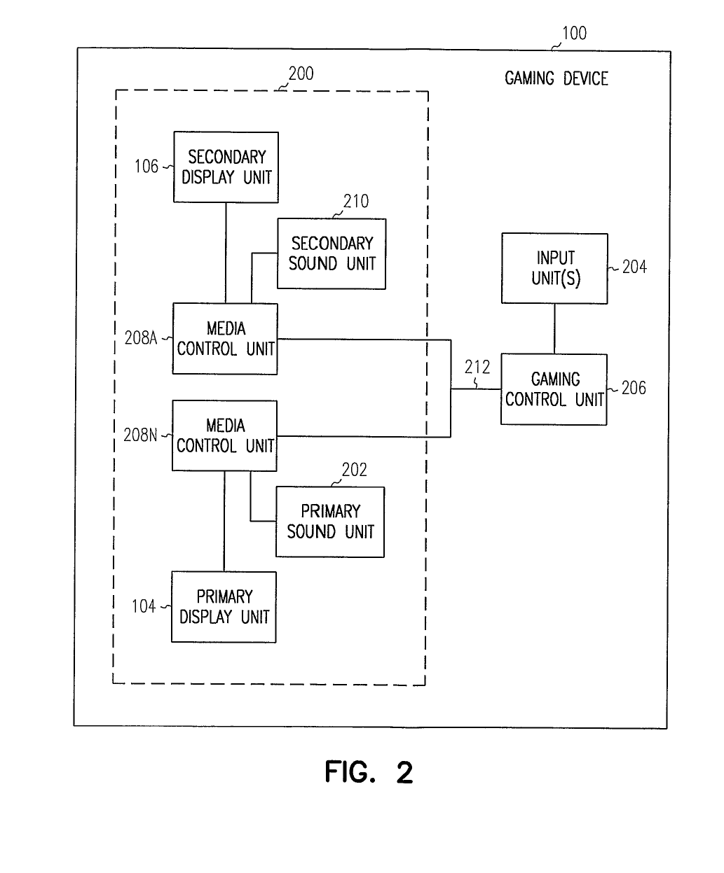

FIG. 2 is a block diagram illustrating components of a gaming device, according to exemplary embodiments of the invention. As shown in FIG. 2, a gaming control unit 206 is connected to an input unit(s) 204 and media control units 208A and 208N. The media control unit 208N is connected to a primary display unit 104 and a primary sound unit 202. The media control unit 208A is connected to a secondary display unit 106 and a secondary sound unit 210. In one embodiment the gaming control unit 206 is connected to the media control units 208A and 208N by a serial communications connection 212, while alternative embodiments call for other suitable communication connections (e.g. a parallel communications connection). In one embodiment, the input unit(s) 204 are connected to the gaming device's buttons 110, 114, and 116 (see FIG. 1). As shown in FIG. 2, the secondary display unit 106, media control units 208A and 208N, secondary sound unit 210, primary display unit 104, and primary sound unit 202 make-up a media system 200.

According to embodiments of the invention, the primary sound unit 202 and secondary sound unit 210 can be speakers or other suitable sound projection devices. In one embodiment the primary display unit 104 can be liquid crystal displays (LCDs), cathode ray tubes (CRTs), projection displays, or other suitable display devices. The secondary display unit 106 in one embodiment is a modified LCD display, wherein a mask is utilized to create the illusion of a low tech display.

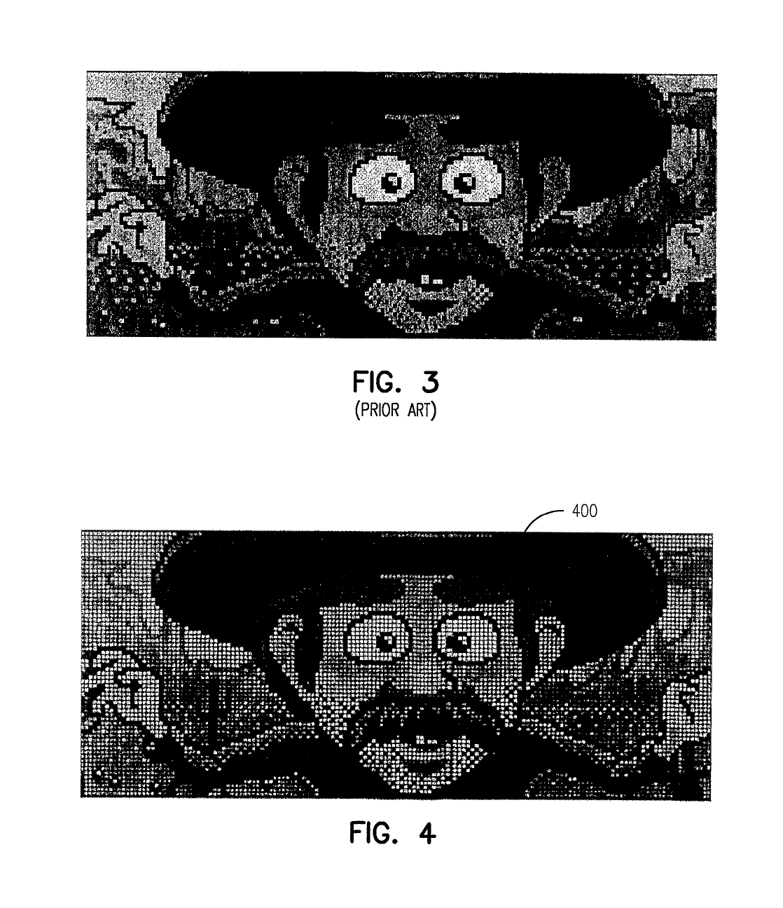

An example of content displayed on secondary display unit 106 is seen in the screen shot of a cowboy 400 in FIG. 4. The mask rounds the corners of groups of pixels that are square as seen in the same image shown in Prior Art FIG. 3. Looking at the teeth of cowboy 400, one can see the difference between the two screen shots. The prior art figure has groups of pixels forming a square left tooth, and a rectangular right tooth. In FIG. 4, with the mask, the left tooth comprises four rounded squares, and the right tooth comprises two rounded squares. The visual effect is one of actually appearing to increase resolution, yet in actuality, less of the image is shown in FIG. 4. Jagged edges, or “jaggies” that appear on the corners of square pixels are eliminated in FIG. 4, creating an illusion. The human brain wants to fill in the “blind spot” created by mask. In this case, the mask is a dot stencil, or pattern of round openings or transparent areas in the mask.

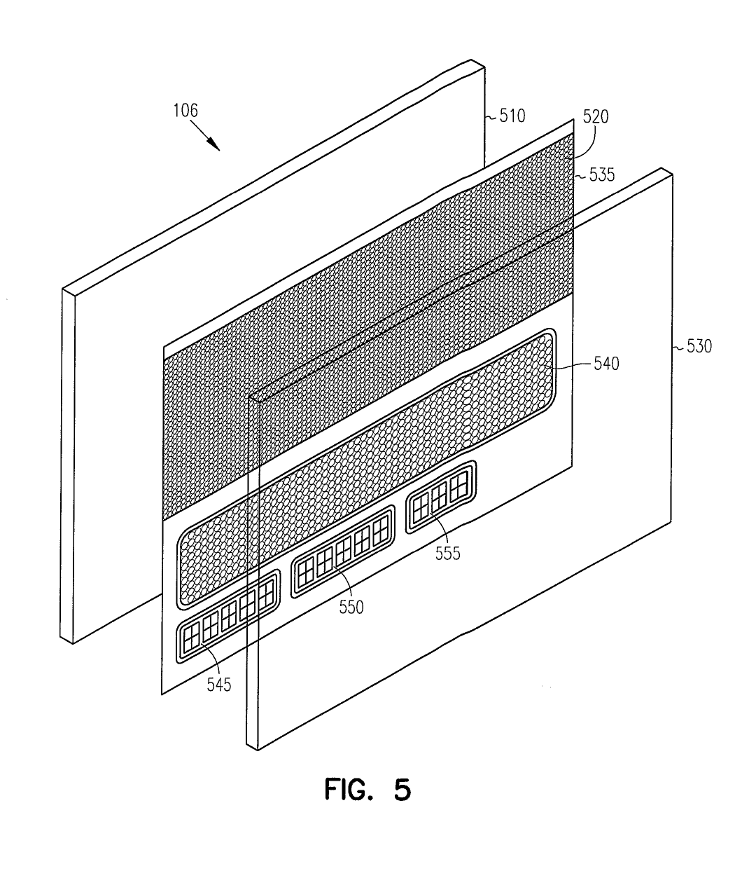

Secondary display unit 106 is shown in further detail in FIG. 5. Secondary display unit 106 comprises an LCD device 510, that is driven by media control unit 208A to provide images in a manner that need not be functionally different from current driving of LCDs. A mask 520 is provided between the LCD device 510 and a protective cover, such as 3/16^{th} inch clear glass 530 or other transparent material of different thickness. Each of these layers may be fixed together by transparent pressure sensitive adhesive, or by other means, such as heat, clamps or other mechanical means. Further layers, such as filters may also be included in the secondary display unit 106. The layers may also be integrated into the LCD display device.

In some embodiments, the mask 520 may have multiple different stencils to create different effects. Three such stencils are shown in FIG. 5. A large pattern of small dots is shown at 535, and covers approximately one-half of the mask. The small dots provide a resolution that appears fairly high, and is likely used to convey images. A rectangular section 540 contains a pattern of larger dots. This may likely be used for text characters, creating a movie theatre marquee effect. A further stencil, indicated at 545, 550 and 555 are used to create an illusion of seven-segment LED displays, such as for use in bonus game meters.

The patterns of dots may be arranged as desired. In one embodiment, they are arranged in a matrix of straight aligned rows and columns. In further embodiments, adjacent rows or columns may be offset as desired, providing a staggered matrix of dots. In still further embodiments, the dots need not be perfectly round, but may be elongated if desired to create a multitude of different effects. Similarly, the segments in the segment stencils may be formed with rounded edges, or sharp edges. Still further shapes of stencils may be used if desired to create many different effects.

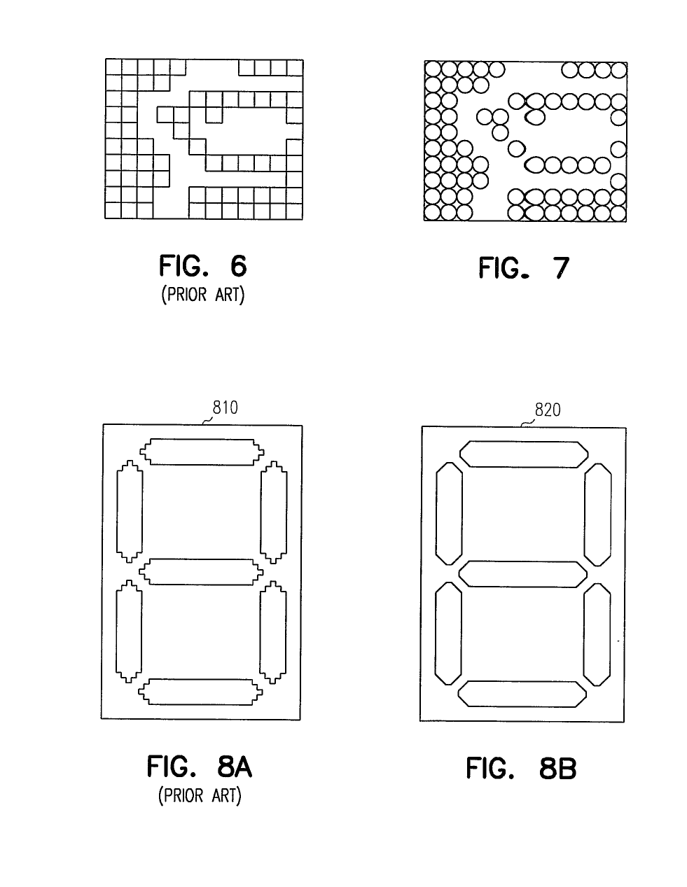

Prior art FIG. 6 shows a portion of an LCD display without a mask. As seen, the pixels, or groups of pixels have very sharp edges, and appear as squares. In FIG. 7, each of the square pixels is masked by a single dot. Care is taken to align the mask such that the dots match up properly with the square pixels. A registration process, such as snapping the layers to a registration point is used in one embodiment. In further embodiments, the stencils are used to change the look of a group of tiny square pixels into the shape of one large round dot or other desired shape.

In yet a further embodiment, graphics may be stored on a flash card that is coupled to the display prior to connection of the display to a gaming device. The flash card contains graphics that are then read by the display and displayed. The stencils in the mask are then aligned with the graphics to correctly position the mask on the display and fasten it by the use of contact adhesive. In one variation, the graphics have a low resolution. In a further variation, the graphics have a resolution similar to a virtual resolution of the stencil pattern of dots.

In still further embodiments, messages on the display, such as a “TILT” message may remain barely visible, or invisible until lit. The message is thus hidden by a transparent black layer in the stencil, or as a separate layer, until light is provided to illuminate the message. This further simulates older games, where the same impression is created.

FIGS. 8A and 8B illustrate the use of seven segment stencils for displaying numeric characters. Screen shot 810 in prior art FIG. 8A shows the display prior to application of the stencil, while screen shot 820 shows the resulting display after the stencil is applied. The stencil shape corresponds to the shape of segments displayed at 820.

In one embodiment, the number of colors used in content for display on the LCD is limited. Five colors are used in one embodiment. Other numbers of colors may also be used to create a desired low-tech effect. Polarized filters may also be used as a layer, or portions of, or the entire mask may be formed from a polarized filter with opaque regions to block light from the LED emitters. The mask comprises a substrate that may be formed of plastic or other suitable material, with the stencil openings formed using photographic, silk screen to laser cutting techniques to selectively allow light to pass through the mask. In one embodiment, the mask is formed of a flexible polymer that may be held in place on a surface of the display by static electricity.

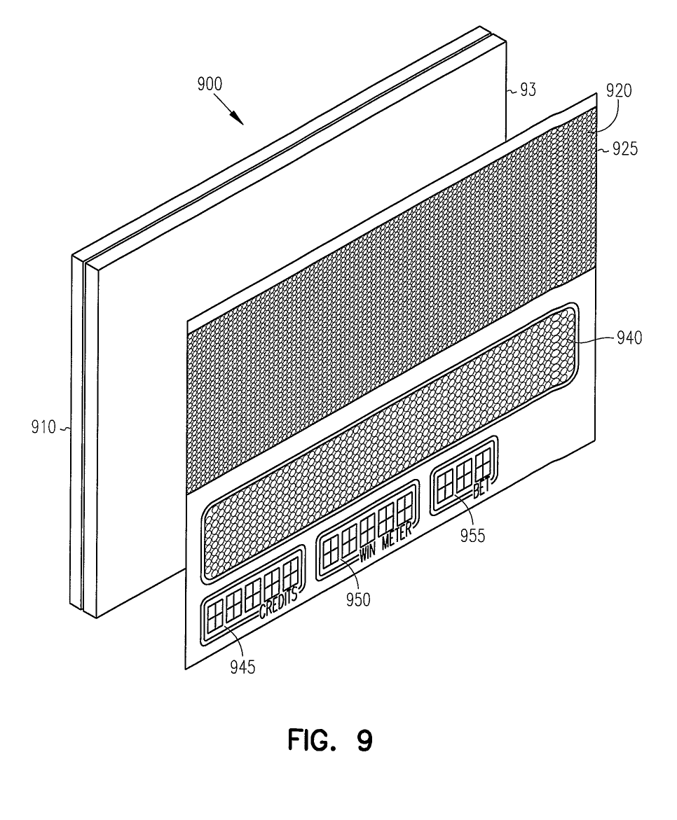

A further embodiment is illustrated in FIG. 9. An LCD device 910 is driven by media control unit 208A to provide images in a manner that need not be functionally different from current driving of LCDs. A mask 920 is provided over the LCD device 510 and a protective cover, such as 3/16^{th} inch clear glass 530 or other transparent material of different thickness. Each of these layers may be fixed together by transparent pressure sensitive adhesive, or by other means, such as heat, clamps or other mechanical means. Mask 920 may also be held in place by static electricity commonly generated by LCD devices. Mask 920 may cover only a portion of the LCD display 910 in one embodiment, leaving a portion of the LCD display 910 exposed and unaffected by the mask.

In some embodiments, the mask 920 may have multiple different stencils to create different effects. Three such stencils are shown in FIG. 9. A large pattern of small dots is shown at 935, and covers approximately one-half of the mask. The small dots provide a resolution that appears fairly high, and is likely used to convey images. A generally rectangular section 940 contains a pattern of larger dots. This may likely be used for text characters, creating a movie theatre marquee effect. A further stencil, indicated at 945, 950 and 955 are used to create an illusion of seven-segment LED displays, such as for use in bonus game meters. The segments may have colored semi-transparent material, such as a red material, to give the effect of a red LCD display. The stencil may also be used to simulate LED progressive meters for gaming displays.

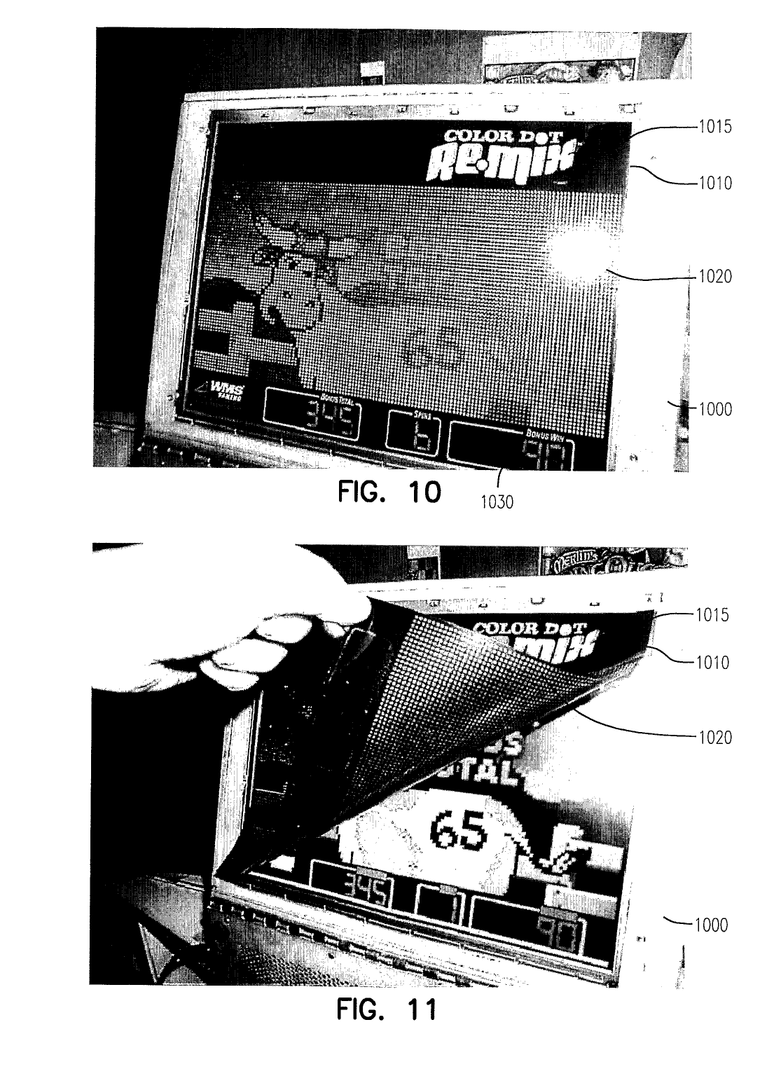

FIG. 10 shows a display device 1000 with a mask 1010 over it. Mask 1010 contains different areas. A substantially opaque area 1015 covers a top portion of the display, and has graphics printed on it. In some embodiments, the opaque area contains a name of the game. Such opaque areas may be located in any desired areas on the mask, and printed or embedded with different text and graphics as desired. Such opaque areas may be partially transparent, or contain different filters to create different desired graphic effects. They may be referred to as graphic areas in further embodiments. Mask 1010 also contains a stencil with dots 1020, and LED type seven-segment stencils 1030 in some embodiments. The dot stencil is used to modify the appearance of a scene, while the seven-segment stencils are used to modify the appearance of alphanumeric characters.

The stencils may be formed by removing opaque layers, or by actually creating holes in the mask. In further embodiments, the opaque and filtered or semitransparent areas are printed on a desired substrate, which may be substantially transparent prior to printing.

FIG. 11 shows the display device 1000 with mask 1010 partially peeled back, exposing areas of raw LCD display. The raw LCD display is somewhat blocky in appearance. For instance, the scene beneath dot stencil 1020 shows at least some large text, a cow, and a fence. The appearance of these scene elements is quite blocky and low resolution in nature. This illustrates the significant difference in appearance that can be obtained through the use of stencil containing masks in some embodiments of the invention. The masks may be used on pinball type machines, significantly improving the appearance of low resolution displays typically used on such games. Masks may also be used as meters above games, as casino signage, and generally with other types of displays used in non-gaming environments.

In the embodiment of FIG. 11, the LCD display displays static graphics, and text which may change, but is located under the seven segment stencils. In further embodiments, motion may be introduced into the graphics, and the dots will still provide a desired effect. In one embodiment, the motion is limited to predetermined areas defined by different stencils in the mask.

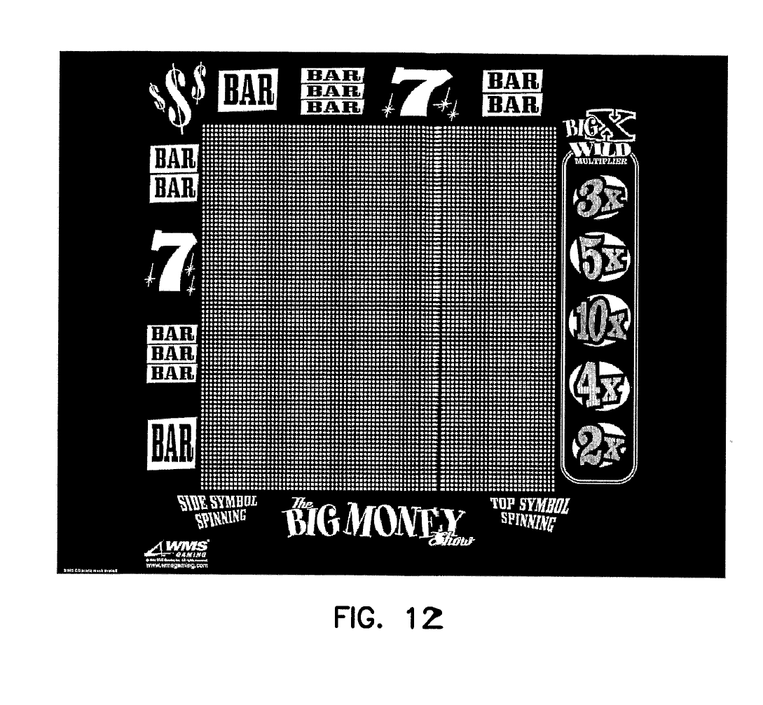

FIG. 12 is a representation of a display device and a mask illustrating pseudo-electroluminescent graphics according to an example embodiment. In this embodiment, the mask consists of a middle portion of dots, which may be used for various types of graphics as determined by the images displayed on the LCD behind the mask. A series of graphics that are stencils in the mask, referred to as multipliers in one game lines the right side of the middle portion of dots, with multiplier graphics “3×”, “5×”, “10×”, “4×”, and “2×”.

In one embodiment, these graphics are silk screened in a color, such as red as shown in the figure. The red color is selectively illuminated by pixels of the underlying LCD, and creates a pseudo-electroluminescent effect. Portions of the colored graphics may be simply openings, with the color of the openings being determined by the colors projected by the underlying pixels. Other graphics are illustrated on other edges of the middle portion of dots, such as the number “7”, the “$”, the various forms of “BAR”, and the wording of “side symbol spinning”, “The BIG MONEY Show”, TOP SYMBOL SPINNING”, and the graphics surrounding the silk screened graphics. The graphics, or stencils may create an appearance of ultra-high resolution, as jagged edges of the underlying pixels may be smoothed by the stencils.

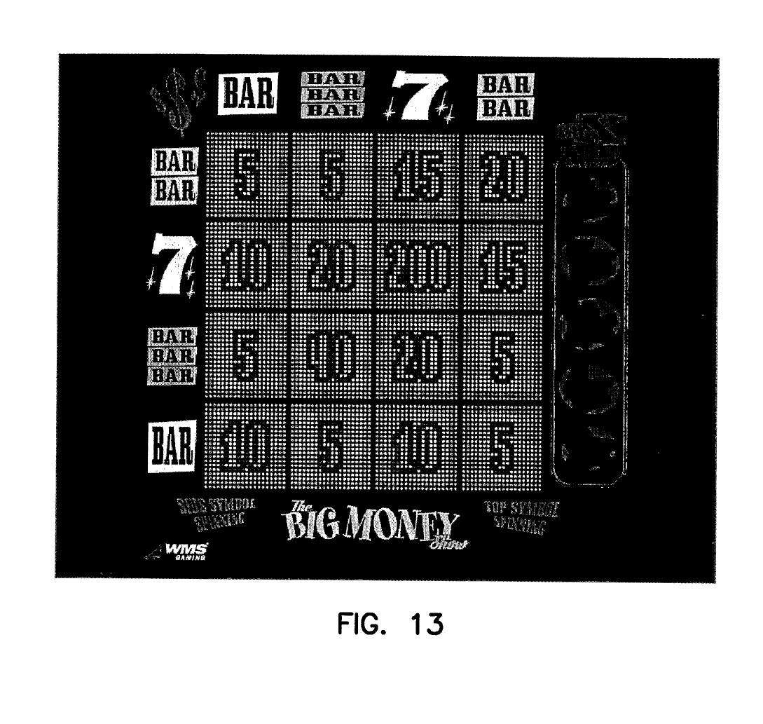

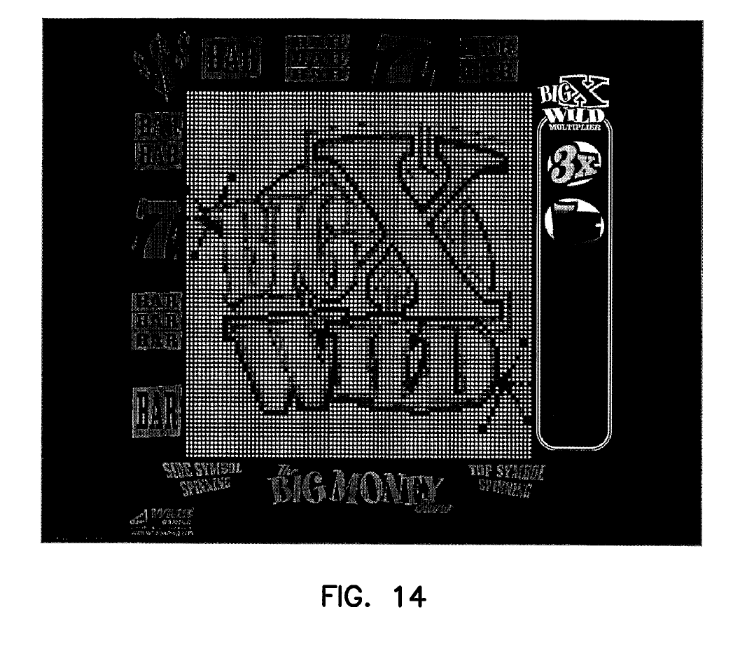

FIG. 13 is a representation of the display device and mask of FIG. 12 illuminated in an alternative manner. The middle portion of dots has been filled in with 16 squares, with a number in each square. The other graphics on the other edges of the middle portion of dots are selectively illuminated, and the multiplier graphics are not illuminated. In this embodiment, the other graphics take on the colors of the underlying pixels, which as seen, may be of many different colors, such as red, pink, blue and green for example.

FIG. 14 is a representation of the display device and mask of FIG. 12 illuminated in a further alternative manner. Only a portion of the multipliers is illuminated in this embodiment, while the middle portion of dots is used to display a large graphic, “BIG×WILD” in multiple different colors. As can be seen from these examples, many different combinations of graphic effects are available. Many different silk screened, or otherwise colored portions of the mask may be formed to create a great variety of pseudo-electroluminescent effects. It will be appreciated that many different types of materials may be used on the mask to create even further effects without departing from the scope of the invention.

1. A gaming device comprising:
a gaming control unit;
a media control unit;
a secondary display device having a mask over an LCD display for masking selected portions of the LCD display to modify the appearance of pixels on the LCD display.

2. The gaming device of claim 1 wherein the mask comprises a stencil of round dots.

3. The gaming device of claim 2 wherein the mask is registered with the LCD to align the round dots with corresponding pixels on the LCD display.

4. The gaming device of claim 2 wherein the dots modify the appearance of the pixels on the LCD display such that they are perceived as round.

5. The gaming device of claim 2 wherein the mask further comprises a stencil of segments.

6. The gaming device of claim 5 wherein the segments are arranged in seven segments units for display of numbers.

7. The gaming device of claim 1 wherein the gaming device comprises a video slot machine.

8. A gaming device comprising:
a primary display unit for presenting a player with video representative of play of a game; and
a secondary display, comprising:
a LCD for displaying content via pixels;
a mask having a stencil for passing selected portions of the pixels; and
a transparent protective layer over the mask.

9. The gaming device of claim 8 wherein the stencil comprises a matrix of dots aligned with the pixels to provide a low-tech appearance.

10. The gaming device of claim 9 wherein the dots are round, and the pixels are square.

11. The gaming device of claim 8 wherein the stencil changes the shape of groups of square pixels into large round dots.

12. A gaming device comprising:
a primary display unit for presenting a player with images representative of play of a game; and
a secondary display, comprising:
a LCD display for displaying content via pixels;
a mask coupled to the LCD having a stencil for passing selected portions of the pixels; and
a transparent protective layer coupled over the mask such that selected portions of the pixels are visible through the mask and transparent layer to provide a low tech appearance of the content.

13. The gaming device of claim 12 wherein the mask comprises a matrix of round dots that smooth edges of the pixels.

14. The gaming device of claim 12 wherein the mask comprises matrices of different size round dots and comprises segments for forming numbers.

15. A gaming device comprising:
a gaming control unit;
means for controlling media;
an LCD display controlled by the means for controlling media; and
means for masking the LCD display to modify the appearance of pixels on the LCD display.

16. A method comprising:
providing content to a LCD display for a secondary display of a gaming device;
representing the content on the LCD in square pixels;
masking the square pixels to smooth edges of the pixels to provide a low-tech appearance to a viewer with an appearance of increased resolution.

17. The method of claim 16 wherein the masking is provided by a stencil of large round openings in a mask.

18. The method of claim 16 and further comprising masking the square pixels to provide seven segment characters.

19. The method of claim 16 wherein the masking is provided by a stencil having a matrix of large round openings in a mask, and a matrix of smaller round openings.

20. The method of claim 19 wherein the masking is further provided by a stencil having segments to provide an appearance of a seven segment LED display.

21. A method comprising:
placing a mask on a display to modify the appearance of pixels being displayed on the display; and
aligning the mask such that selected stencils on the mask line up with corresponding graphics being displayed on the display to provide a low-tech appearance to a viewer with an appearance of increased resolution.

22. The method of claim 21 wherein a seven segment stencil of the mask is aligned with alphanumeric characters being displayed on the display.

23. The method of claim 21 wherein a dot matrix stencil of the mask is aligned with a graphic image of a scene being displayed on the display.

24. The method of claim 21 wherein the mask covers only a portion of the display and is aligned with selected graphics being displayed on the display.

25. The method of claim 21 and further comprising fixing the mask to a top surface of the display.

26. The method of claim 25 wherein the mask is fixed with pressure sensitive adhesive.

27. The method of claim 25 wherein the mask is fixed with static electricity.

28. The method of claim 21 and further comprising selectively filtering light transmitted from the display through the mask.

29. The method of claim 21 wherein the graphics being displayed are provided by a flash card.

30. A mask comprising:
a substrate formed to attach to a display;
a matrix of dots in the substrate that allow light to pass through the dots, wherein the dots are formed on the substrate in a position to smooth edges of display pixels to provide a low-tech appearance to a viewer with an appearance of increased resolution.

31. The mask of claim 30 wherein the substrate is formed of a flexible material.

32. The mask of claim 30 and further comprising a filter.

33. The mask of claim 30 and further comprising a seven-segment character stencil formed in the substrate.

34. The mask of claim 30 and further comprising an area of the substrate containing graphic images.

35. The mask of claim 30 and further comprising a transparent black layer that hides unlit graphics and alphanumeric characters.

36. A mask comprising:
a substrate formed to attach to a display;
a matrix of dots in the substrate that allow light to pass through the dots, wherein the dots are formed on the substrate in a position to smooth edges of display pixels to provide a low-tech appearance to a viewer with an appearance of increased resolution;
a plurality of seven-segment character stencils in the substrate in a position corresponding to characters to be displayed on the display; and
a filter supported by the substrate to filter light through the seven-segment character stencils.

37. The mask of claim 36 and further comprising an area of the substrate containing graphic images.

38. The mask of claim 36 and further comprising substantially opaque areas on the substrate that allow some light to pass through from the display.

39. A mask comprising:
a substantially opaque substrate formed to attach to a display;
a matrix of dots in the substrate that allow light to pass through the dots, wherein the dots are formed on the substrate in a position to smooth edges of display pixels to provide a low-tech appearance to a viewer with an appearance of increased resolution;
a plurality of seven-segment character stencils in the substrate in a position corresponding to characters to be displayed on the display; and
wherein the stencils comprise areas of removed substantially opaque material supported by the substrate.

40. The mask of claim 39, wherein the stencils correspond to holes in the substrate.

41. A mask comprising:
a substrate formed to attach to a display having pixels; and
a stencil in the substrate that allows light to pass through the substrate, wherein portions of the stencil are colored to provide pseudo-electroluminescent graphics when lit by pixels of the display.

42. The mask of claim 41 wherein the stencil is completely colored.

43. The mask of claim 41 wherein the stencil is colored by silk screening.

44. The mask of claim 41 wherein the mask further comprises a matrix of dots that allow light to pass through the dots, wherein the dots are formed on the mask in a position to smooth edges of the display pixels to provide a low-tech appearance to a viewer with an appearance of increased resolution.

45. The mask of claim 41 and further comprising a plurality of stencils allowing light to pass through the mask, such that at least part of a stencil creates an appearance of ultra-high resolution.

46. The mask of claim 45 wherein jagged edges of the underlying pixels are smoothed by the stencils.
